(19) United States
(12) Patent Application Publication
(10) Pub. No.: US 2024/0414563 A1
(43) Pub. Date: Dec. 12, 2024

(54) WIRELESS FEDERATED k-MEANS CLUSTERING WITH NON-COHERENT OVER-THE-AIR COMPUTATION

(71) Applicant: University of South Carolina, Columbia, SC (US)

(72) Inventor: Alphan Sahin, Columbia, SC (US)

(73) Assignee: University of South Carolina, Columbia, SC (US)

(21) Appl. No.: 18/670,031

(22) Filed: May 21, 2024

Related U.S. Application Data
(60) Provisional application No. 63/506,639, filed on Jun. 7, 2023.

(51) Int. Cl. H04W 24/02; G06N 3/098

(52) U.S. Cl. CPC H04W 24/02; G06N 3/098

(57) ABSTRACT

Described herein is an over-the-air computation (OAC) scheme for a federated k-means clustering algorithm to reduce the per-round communication latency when implemented over a wireless network. The OAC scheme relies on an encoder exploiting the representation of a number in a balanced number system and computes the sum of the updates for the federated k-means via signal superposition property of wireless multiple-access channels non-coherently to eliminate the need for precise phase and time synchronization.

### TECHNICAL FIELD

The subject matter disclosed herein is generally directed to an over-the-air computation (OAC) scheme for a federated k-means clustering algorithm to reduce the per-round communication latency when implemented over a wireless network. The OAC scheme relies on an encoder exploiting the representation of a number in a balanced number system and computes the sum of the updates for the federated k-means via signal superposition property of wireless multiple-access channels non-coherently to eliminate the need for precise phase and time synchronization.

### BACKGROUND

Over-the-air computation (OAC) is a physical layer concept that can benefit a wide variety of applications for function computation over a bandwidth-limited wireless channel by reducing resource utilization to a one-time cost that does not scale with the number of edge devices (EDs). See, A., Sahin and R. Yang, “A survey on over-the-air computation,” IEEE Communications Surveys & Tutorials, pp. 1-32, 2023. It exploits the signal superposition property of wireless multiple-access channels to compute a set of special mathematical functions such as arithmetic mean and sum. See, B. Nazer and M. Gastpar, “Computation over multiple-access channels,” IEEE Trans. Inf. Theory, vol. 53, no. 10, pp. 3498-3516 October 2007; M. Goldenbaum, H. Boche, and S. Sta' nczak, “Harnessing interference for analog function computation in wireless sensor networks,” IEEE Trans. Signal Process., vol. 61, no. 20, pp. 4893-4906, 2013; and “Nomographic functions: Efficient computation in clustered Gaussian sensor networks,” IEEE Trans. Wireless Commun., vol. 14, no. 4, pp. 2093-2105, 2015. With the increased attention to computation-oriented applications over wireless networks, OAC has been utilized as a fundamental tool to improve communication latency. For example, in A., Sahin, “Distributed learning over a wireless network with noncoherent majority vote computation,” IEEE Trans. Wireless Commun., pp. 1-16, 2023; G. Zhu, Y. Wang, and K. Huang, “Broadband analog aggregation for low-latency federated edge learning,” IEEE Trans. Wireless Commun., vol. 19, no. 1, pp. 491-506, January 2020; and G. Zhu, Y. Du, D. Gündüz, and K. Huang, “One-bit over-the-air aggregation for communication-efficient federated edge learning: Design and convergence analysis,” IEEE Trans. Wireless Commun., vol. 20, no. 3, pp. 2120-2135 November 2021, OAC is used for aggregating gradients or model parameters of neural networks for supervised distributed training, such as federated learning (FL), see B. McMahan, E. Moore, D. Ramage, S. Hampson, and B. A. y. Arcas, “Communication-Efficient Learning of Deep Networks from Decentralized Data,” in Proc. International Conference on Artificial Intelligence and Statistics (AISTATS), A. Singh and J. Zhu, Eds., vol. 54. PMLR, April 2017, pp. 1273-1282, over a wireless network to improve per-round communication latency.

It is an object of the present disclosure to provide an unsupervised federated learning algorithm, i.e., the federated k-means algorithm, over wireless networks.

Citation or identification of any document in this application is not an admission that such a document is available as prior art to the present disclosure.

### SUMMARY

The above objectives are accomplished according to the present disclosure by providing in one instance a method for an over-the-air computation (OAC) scheme. The method may include obtaining access to at least one wireless network with at least one edge device and one edge server connected over the at least one wireless network, reducing per-round communication latency via computing a sum of at least one update for a federated k-means clustering algorithm via signal superposition property of wireless multiple-access channels non-coherently; eliminating a need for precise phase and time synchronization as the at least one edge device does not use channel state information; and employing a federated k-means clustering algorithm to reduce the per-round communication latency when implemented over a wireless network. Further, the method may include, reinitializing at least one centroid to increase performance for heterogeneous data distribution via employing the federated k-means clustering algorithm. Still further, the system may include wherein the at least one centroid has a small cardinality in a corresponding partition. Even further, the system may include utilizing a maximum-value adaptation method to reduce quantization error. Yet further again, a number of complex-valued resources consumed for each communication round can be calculated as LCβD and are not scaled with a number of edge devices. Still yet further, the federated k-means clustering algorithm may include:

Input: c₁⁽⁰⁾,..., c_{C}⁽⁰⁾, vₘₐₓ⁽⁰⁾, Sₘᵢₙ, μ, α, σ_{c}², β, D, N
Output: c₁^{(N)},..., c_{C}^{(N)}
for n = 1 : N do

| | |
|---|---|
| \| | /* Processing @ EDs |
| \| | for k = 1 : K do |
| \| | \| Compute [symbol] _{k,c}⁽ⁿ⁾ with (3), ∀c |
| \| | \| Compute Δc_{k,c}⁽ⁿ⁾ with (6), ∀c |
| \| | \| Compute x_{k,l}⁽ⁿ⁾ with (10), ∀l |
| \| | \|_{—} |
| \| | /* Superposition in the uplink |
| \| | The EDs transmit the OFDM symbols simultaneously for OAC |
| \| | The EDs transmit \| [symbol] _{k,c}⁽ⁿ⁾\|, mₖ⁽ⁿ⁾, ∀c |
| \| | /* Processing @ ES |
| \| | Compute \hat{v}_{q}⁽ⁿ⁾ with (11), ∀ |
| \| | Update vₘₐₓ⁽ⁿ⁺¹⁾ with (12) |
| \| | Update c_{c′}⁽ⁿ⁺¹⁾ with (5), ∀c′ ∈ [symbol] ^{c} |
| \| | Update c_{c″}⁽ⁿ⁺¹⁾ with (III-C), ∀c″ ∈ [symbol] |
| \| | /* Broadcast in the downlink |
| \| | The ES broadcasts vₘₐₓ⁽ⁿ⁺¹⁾, c_{c}⁽ⁿ⁺¹⁾, ∀c |
| \|_{—} | |

In a further embodiment, the current disclosure provides a system for addressing per round communication latency. The system may include at least one edge device connected to at least one edge server over at least one wireless network, employing at least one wireless federated k-means clustering algorithm along with an over-the-air computation scheme such that no channel state information is required for the at least one edge device or the at least one edge server wherein employing the at least one wireless federated k-means clustering algorithm further utilizes a maximum-value adaption method to reduce at least one quantization error and employs a re-initialization strategy for at least one centroid. Further yet, the at least one centroid has a small cardinality. Even further, a number of complex-valued resources consumed for each communication round can be calculated as LCβD and are not scaled with a number of edge devices. Still further yet, the federated k-means clustering algorithm comprises:

Input: c₁⁽⁰⁾,..., c_{C}⁽⁰⁾, vₘₐₓ⁽⁰⁾, Sₘᵢₙ, μ, α, σ_{c}², β, D, N
Output: c₁^{(N)},..., c_{C}^{(N)}
for n = 1 : N do

| | |
|---|---|
| \| | /* Processing @ EDs |
| \| | for k = 1 : K do |
| \| | \| Compute [symbol] _{k,c}⁽ⁿ⁾ with (3), ∀c |
| \| | \| Compute Δc_{k,c}⁽ⁿ⁾ with (6), ∀c |
| \| | \| Compute x_{k,l}⁽ⁿ⁾ with (10), ∀l |
| \| | \|_ |
| \| | /* Superposition in the uplink |
| \| | The EDs transmit the OFDM symbols simultaneously for OAC |
| \| | The EDs transmit \| [symbol] _{k,c}⁽ⁿ⁾\|, mₖ⁽ⁿ⁾, ∀c |
| \| | /* Processing @ ES |
| \| | Compute \hat{v}_{q}⁽ⁿ⁾ with (11), ∀ |
| \| | Update vₘₐₓ⁽ⁿ⁺¹⁾ with (12) |
| \| | Update c_{c′}⁽ⁿ⁺¹⁾ with (5), ∀c′ ∈ [symbol] ^{c} |
| \| | Update c_{c″}⁽ⁿ⁺¹⁾ with (III-C), ∀c″ ∈ [symbol] |
| \| | /* Broadcast in the downlink |
| \| | The ES broadcasts vₘₐₓ⁽ⁿ⁺¹⁾, c_{c}⁽ⁿ⁺¹⁾, ∀c |
| \|_{—} | |

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a graph of one clustering scenario.

FIG. 2 shows graphs of the loss over the communication rounds for the wireless federated k-means with OAC (Sₘᵢₙ=0).

FIG. 3 shows the loss over the communication rounds for the wireless federated k-means with OAC (Sₘᵢₙ=5).

FIG. 4 shows graphs of final centroids for the wireless federated k-means with OAC (SNR=10 dB, Sₘᵢₙ=0).

FIG. 5 shows graphs of final centroids for the wireless federated k-means with OAC (SNR=10 dB, Sₘᵢₙ=5).

FIG. 6 shows Table 1, Algorithm 1: Wireless federated k-means with OAC.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### KITS

Any of the systems and methods for over the air computation for obtaining an unsupervised federating learning algorithm over wireless networks described herein can be presented as a combination kit. As used herein, the terms “combination kit” or “kit of parts” refers to the components, parts, pieces, modules, encoders, network access, and any additional components that are used to package, sell, market, deliver, and/or provide the combination of elements or a single element, such as the systems and methods described herein. Such additional components include, but are not limited to, packaging, blister packages, and the like. When one or more of the components, parts, pieces, modules, and any additional components described herein or a combination thereof (e.g., systems and methods for over the air computation for obtaining an unsupervised federating learning algorithm over wireless networks with constituent parts/pieces for installation) contained in the kit are provided simultaneously, the combination kit can contain the systems and methods for over the air computation for obtaining an unsupervised federating learning algorithm over wireless networks alone or they can be provided with other accoutrements for installation, modification, and/or upkeep. When the components, parts, pieces, modules, and any additional components described herein or a combination thereof and/or kit components are not provided simultaneously, the combination kit can contain the necessary accoutrements for the systems and methods and constituent parts in separate combinations. The separate kit components can be contained in a single package or in separate packages within the kit.

In some embodiments, the combination kit also includes instructions printed on or otherwise contained in a tangible medium of expression. The instructions can provide information regarding the systems or methods disclosed herein, installation/upkeep/maintenance information, information regarding use, etc. In some embodiments, the instructions can provide directions and protocols for installing or using the systems and methods or providing maintenance to same. In some embodiments, the instructions can provide one or more embodiments of the methods for making/implementing the systems and methods of the current disclosure as any of the systems or methods described in greater detail elsewhere herein.

In this disclosure, we use an over-the-air computation (OAC) scheme for the federated k-means clustering algorithm to reduce the per-round communication latency when it is implemented over a wireless network. The OAC scheme relies on an encoder exploiting the representation of a number in a balanced number system and computes the sum of the updates for the federated k-means via signal superposition property of wireless multiple-access channels non-coherently to eliminate the need for precise phase and time synchronization. Also, a reinitialization method for ineffectively used centroids is proposed to improve the performance of the proposed method for heterogeneous data distribution. For a customer-location clustering scenario, we demonstrate the performance of the proposed algorithm and compare it with the standard k-means clustering. Our results show that the proposed approach performs similarly to the standard k-means while reducing communication latency.

The k-means algorithm is a well-known algorithm that successively partitions a dataset to improve a metric that measures cluster formation. In the literature, it has been analyzed for various distributed settings. For instance, in G. Jagannathan and R. N. Wright, “Privacy-preserving distributed k-means clustering over arbitrarily partitioned data,” in Proc. ACM International Conference on Knowledge Discovery in Data Mining, New York, NY, USA, 2005, pp. 593-599, the authors introduce a privacy-preserving protocol, which relies on exchanging the centroids between two parties with vertically-or horizontally-partitioned data. The federated k-means algorithm is first explicitly mentioned in, H. H. Kumar, K. V R, and M. K. Nair, “Federated k-means clustering: A novel edge AI based approach for privacy preservation,” in Proc. IEEE International Conference on Cloud Computing in Emerging Markets (CCEM), 2020, pp. 52-56, where the authors apply it to a clustering task based on MNIST and EMNIST datasets. In D. K. Dennis, T. Li, and V. Smith, “Heterogeneity for the win: One-shot federated clustering,” ser. Proceedings of Machine Learning Research, M. Meila and T. Zhang, Eds., vol. 139, July 2021, pp. 2611-2620, a one-shot federated clustering scheme is proposed. In this method, the EDs run the k-means locally and send the clustering results to the edge server(ES) for aggregation. In A. Ghosh, J. Chung, D. Yin, and K. Ramchandran, “An efficient framework for clustered federated learning,” IEEE Transactions on Information Theory, vol. 68, no. 12, pp. 8076-8091, 2022, one-shot federated clustering is extended to an iterative federated clustering algorithm. See, for guaranteeing the privacy of federated k-means, in S. Li, S. Hou, B. Buyukates, and S. Avestimehr, “Secure federated clustering,” 2022, it is proposed to use Lagrange encoding on local data and share the coded data samples across the EDs along with noise injection. In M. Stallmann and A. Wilbik, “On a framework for federated cluster analysis,” Applied Sciences, vol. 12, no. 20, 2022, a federated clustering framework that determines the number of global clusters and validates the clustering via Davies-Bouldin index. In X. Zhou and X. Wang, “Memory and communication efficient federated kernel k-means,” IEEE Trans. Neural Net. Learn. Syst., pp. 1-12, 2022, the memory and communication efficiency of the federated k-means is proposed to be reduced by using the low-dimensional features of the local data samples. In K. Yang, M. M. Amiri, and S. R. Kulkarni, “Greedy centroid initialization for federated k-means,” in Proc. IEEE Annual Conference on Information Sciences and Systems (CISS), 2023, pp. 1-6, it is proposed to initialize the centroids at the EDs for better centroid initialization.

To the best of our knowledge, the federated k-means algorithm over a wireless network with OAC is not investigated in the literature. Here, we propose to implement the federated k-means algorithm over wireless networks with a non-coherent OAC based on balanced number systems A. Sahin, “Over-the-air computation based on balanced number systems for federated edge learning,” 2023. [Online]. Available: arxiv.org/abs/2210.07012. The proposed approach reduces per-round communication latency by computing the sum of the local updates for clustering over the air while promoting data privacy via federation. To improve the performance of clustering while taking the data heterogeneity into account, we use a maximum adaptation approach for the OAC scheme and employ a simple-but effective re-initialization method for the centroids that have small number of data samples. We compare the proposed algorithm with the case when the global dataset is available at a central server for various OAC configurations under different channel conditions.

### SYSTEM MODEL

### A. Problem Statement

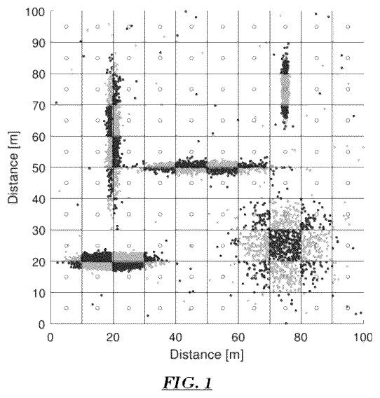

Consider a scenario where K EDs are connected to an ES over a wireless network. Let D_{K} denote the dataset available at the kth ED, where a data sample d in Dₖ is an L-dimensional real vector, ∀k. Suppose that the EDs are not willing to share their datasets with the ES due to privacy considerations. Under this constraint, the objective of each ED is to learn where data samples are clustered in the global dataset, i.e., D=D1∪D2∪ . . . ∪DK, for further inference. For instance, consider the rectangular tessellation given in FIG. 1. FIG. 1 shows one possible clustering scenario. Each tile corresponds to a retail store in a mall, where each store has a local dataset containing their customers' locations (black and gray points). The stores are interested in where the customers are clustered in the mall without uploading their datasets to a central server. FIG. 1 shows 100 tiles, where each tile corresponds to a retail store in a mall. Each retail store has a dataset that contains the precise x- and y-coordinates of their customers' locations, i.e., the points that reside within the corresponding tile. For this scenario, to assess the customers' preferences, each store is interested in where the points (e.g., customers' locations) are clustered in the entire mall without uploading their datasets to a central server. For this example, the EDs may be local radios at the retail stores, connected to a base station, i.e., an ES, located at the center of the mall. As can be seen from FIG. 1, the data distributions and the cardinalities of datasets at the EDs can widely vary since each dataset contains only the customers' positions within the store.

The aforementioned scenario can be expressed as an optimization problem seeking for the centroids of C disjoint clusters S₁, . . . , S_{C} that partition the set D to minimize a loss function given by

$$f ( {𝒮}_{1} , … , {𝒮}_{C} ) = {\sum }_{c = 1}^{C} {\sum }_{d ∈ {𝒮}_{c}} {‖ d - {μ}_{c} ‖}_{2}^{2} , \qquad ( 1 )$$

where

$${μ}_{c} = \frac{1}{\vert {𝒮}_{C} \vert} {\sum }_{d ∈ {𝒮}_{c}} d$$

is the centroid of cth cluster. The minimization of (1) is

NP-hard, see M. Garey, D. Johnson, and H. Witsenhausen, “The complexity of the generalized lloyd—max problem (corresp.),” IEEE Transactions on information Theory, vol. 28, no. 2, pp. 255-256, 1982. Hence, we consider an approximate solution via the k-means clustering algorithm.

The standard k-means algorithm aims to solve (1) iteratively. For a given a set of centroids c₁⁽ⁿ⁾, . . . , c_{C}⁽ⁿ⁾, it calculates the cth cluster based on Euclidean distance as [symbol] _{c}⁽ⁿ⁾={d∥|d−c_{c}⁽ⁿ⁾∥₂²≤∥d−c_{c′}⁽ⁿ⁾∥₂²,∀c′}. Subsequently, the cth centroid is updated as:

$${c}_{c}^{( n + 1 )} = ( 1 - μ ) {c}_{c}^{( n )} + μ \frac{1}{\vert {𝒮}_{c}^{( n )} \vert} {\sum }_{d ∈ {𝒮}_{c}^{( n )}} d , \qquad ( 2 )$$

for | [symbol] _{c}⁽ⁿ⁾|>0, where μ is the learning rate and equal to 1 for the standard k-means algorithm.

For our scenario, the partition | [symbol] _{c}⁽ⁿ⁾|>0, ∀c, cannot be formed since the global dataset is not available at the ES. With federated k-means, clustering can be achieved without the global dataset as follows: The ES distributes c₁⁽ⁿ⁾, . . . ,c_{C}⁽ⁿ⁾ to the EDs for the nth iteration. Given the centroids, each ED computes the local clusters based on its local dataset as

$${𝒮}_{k , c}^{( n )} \{ d \vert {‖ d - {c}_{c}^{( n )} ‖}_{2}^{2} \leq {‖ d - {c}_{{c}^{′}}^{( n )} ‖}_{2}^{2} , ∀ {c}^{′} , d ∈ {𝒟}_{k} \} . \qquad ( 3 )$$

The update step in (2) can then be re-expressed as

$${c}_{c}^{( n + 1 )} = ( 1 - μ ) {c}_{c}^{( n )} + μ \frac{1}{\vert {𝒮}_{c}^{( n )} \vert} {\sum }_{k = 1}^{K} {\sum }_{d ∈ {𝒮}_{k , c}^{( n )}} d \qquad ( 4 )$$

$$= {c}_{c}^{( n )} + μ \frac{1}{\vert {𝒮}_{c}^{( n )} \vert} {\sum }_{k = 1}^{K} Δ {c}_{k , c}^{( n )} , \qquad ( 5 )$$

for | [symbol] _{c}⁽ⁿ⁾|=Σₖ₌₁^{K}| [symbol] _{k,c}⁽ⁿ⁾|>0 and Δc_{k,c}⁽ⁿ⁾ is defined by

$$Δ {c}_{k , c}^{( n )} {\sum }_{d ∈ {𝒮}_{k , c}^{( n )}} d - {c}_{c}^{( n )} . \qquad ( 6 )$$

Thus, with the federated k-means algorithm, the kth ED shares either the sum of data samples within the cluster or the total change with the ES, as can be seen in (4) and (5), respectively. Since the data samples are not shared with the federated k-means algorithm, the privacy is improved at the expense of per-round communication latency (or resource utilization) that grows linearly with the number of EDs due to the communication between the EDs and the ES. In this work, we address the latency issue of the federated k-means over wireless networks with OAC.

### B. Signal Model and Wireless Channel

We assume that each ED and the ES are equipped with a single antenna and the large-scale impact of the wireless channel is compensated with a state-of-the-art power control mechanism, see E. Dahlman, S. Parkvall, and J. Skold, 5G NR: The Next Generation Wireless Access Technology, 1st ed. USA: Academic Press, Inc., 2018. For the signal model, we assume that the EDs access the wireless channel on the same time-frequency resources simultaneously with orthogonal frequency division multiplexing (OFDM) symbols. Assuming that the cyclic prefix (CP) duration is larger than the sum of the maximum time-synchronization error and the maximum-excess delay of the channel, the received symbol on the lth resource (e.g., an OFDM subcarrier) can be expressed as

$${y}_{l}^{( n )} = {\sum }_{k = 1}^{K} {h}_{k , l}^{( n )} {x}_{k , l}^{( N )} + {w}_{l}^{( n )} , \qquad ( 7 )$$

where h_{k,l}⁽ⁿ⁾˜ [symbol] (0,1) is the channel coefficient between the ES and the kth ED, [symbol] _{k,l}⁽ⁿ⁾∈ [symbol] the transmitted symbol from the kth ED, and wₗ⁽ⁿ⁾˜ [symbol] (0,σₙ²) is zero-mean symmetric additive white Gaussian noise (AWGN) with the variance σₙ². SNR=1/σₙ² denotes the signal-to-noise ratio (SNR) of an ED at the ES receiver.

### FEDERATED k-MEANS WITH NON-COHERENT OAC

In this section, we discuss how we address the communication bottleneck of wireless federated k-means by computing the sum in (5) with a non-coherent OAC scheme without using the channel state information (CSI), i.e., h_{k,l}⁽ⁿ⁾, ∀k, ∀l, at the EDs and ES. To this end, we consider the OAC scheme that exploits balanced number systems, see A. Sahin, “Over-the-air computation based on balanced number systems for federated edge learning,” 2023. [Online]. Available: arxiv.org/abs/2210.07012.

### A. Edge Device—Transmitter

Let υ_{k,q}⁽ⁿ⁾ be the (q+1)th element of

$$vec ( [ Δ {c}_{k , 1}^{( n )} , … , Δ {c}_{k , C}^{( n )} ] ) ∈ {LC}^{} for q ∈ \{ 0 , 1 , … , LC - 1 \} ,$$

where vec(⋅) is the vectorization operation. The kth ED encodes υ_{k,q}⁽ⁿ⁾ into a sequence of length D as

$$( {η}_{k , q , K - 1}^{( n )} , … , {η}_{k , q , d}^{( n )} , … , {η}_{k , q , 0}^{( n )} ) = {f}_{enc , β} ( {v}_{k , q}^{( n )} ) , \qquad ( 8 )$$

for

$${η}_{k , d}^{( n )} ∈ \{ {s}_{j} \vert {s}_{j} = j - ( β - 1 ) / 2 , j ∈ \{ 0 , 1 , … , β - 1 \} \} ,$$

∀d, where β is an odd positive integer (i.e., base) and f_{enc,β} is a function that maps υ_{k,q}⁽ⁿ⁾ to a sequence of D numerals in a balanced number system with base β. The numerals are obtained via f_{enc,β}(υ_{k,q}⁽ⁿ⁾) as follows:
1) υ_{k,q}⁽ⁿ⁾ is clamped as υ′=max (−υₘₐₓ, min (υ_{k,q}⁽ⁿ⁾, υₘₐₓ)) to ensure υ′∈[−υₘₐₓ, υₘₐₓ] for a given υₘₐₓ>0.
2) υ′ is re-scaled as

$$\frac{ξ}{{v}_{max}} {v}^{′} + ξ + \frac{1}{2} .$$

3) The scaled value is mapped to an integer between 0 and 2ξ with a floor operation and the corresponding integer is expanded as

$$⌊ \frac{ξ}{{v}_{max}} {v}^{′} + ξ + \frac{1}{2} ⌋ = {\sum }_{d = 0}^{D - 1} {b}_{d} {β}^{d} ,$$

for b_{k,d}∈ [symbol] _{β} and ξ [symbol] (β^{D}−1)/2.
4) η_{k,q,d}⁽ⁿ⁾ is calculated as η_{k,q,d}⁽ⁿ⁾=b_{d}−(β−1)/2, ∀d.

It is worth noting that the quantized υ_{k,q}⁽ⁿ⁾ can be obtained as

$${\overline{v}}_{k , q}^{( n )} = {f}_{dec , β} ( {η}_{k , q , D - 1}^{( n )} , … , {η}_{k , q , 0}^{( n )} ) \frac{{v}_{max}}{ξ} {\sum }_{d = 0}^{D - 1} {η}_{k , q , d}^{( n )} {β}^{d} . \qquad ( 9 )$$

We refer the reader to A. Sahin, “Over-the-air computation based on balanced number systems for federated edge learning,” 2023. [Online]. Available: arxiv.org/abs/2210.07012 for several numerical examples with _{fenc.β} and f_{dec,β}.

Without loss of generality, in this disclosure, we use a resource mapping rule given by 1=βDq+βd+j for a given triplet (q, d, j). Based on the numerals obtained in (8), we compute the transmitted symbol [symbol] _{k,l}⁽ⁿ⁾ (7) as

$${x}_{k , l}^{( n )} = \sqrt{{E}_{s}} {r}_{k , l}^{( n )} \times [ {η}_{k , q , d}^{( n )} = {s}_{j} ] , \qquad ( 10 )$$

Sⱼ∈ [symbol] _{β}, where Eₛ [symbol] \sqrt{β} is the symbol energy, r_{k,l}⁽ⁿ⁾ is a random quadrature phase-shift keying (QPSK) symbol to improve the peak-to-mean envelope power ratio (PMEPR) of the corresponding OFDM waveform, and the function II [⋅] results in 1 if its argument holds, otherwise, it is 0. Thus, with (10), β complex-valued resources are dedicated to each numeral, and one of them is activated based on its value.

Since all EDs access the spectrum simultaneously for OAC, the number of complex-valued resources consumed for each communication round can be calculated as LCβD and not scaled with the number of EDs. Also, as the EDs do not use CSI, not only the channel estimation overhead but also the need for phase and precise time synchronizations are eliminated with the aforementioned OAC scheme. Note that, without OAC, the number of resources required may be roughly calculated as LCK_{rbitsrcompression}N_{bits}, where r_{bits} is the spectral efficiency in bits/s/Hz, r_{compression} is the compression ratio, Nbits is the number of bits for representing υ_{k,q}^{(n).}

### Edge Server—Receiver

At the ES, we exploit the fact that the (q+1) th element of vec(Σₖ₌₁^{K}Δc_{k,1}⁽ⁿ⁾, . . . , Σₖ₌₁^{K}Δc_{k,C}ⁿ⁾), denoted by υ_{q}⁽ⁿ⁾, can be obtained approximately by using (9) as

$${v}_{q}^{( n )} = {\sum }_{k = 1}^{K} {v}_{k , q}^{( n )} \underline{\approx } {\sum }_{k = 1}^{K} {\overline{v}}_{k , q}^{( n )} = \frac{{v}_{max}}{ξ} {\sum }_{d = 0}^{D - 1} {\sum }_{k = 1}^{K} {η}_{k , q , d}^{( n )} {β}^{d} = {f}_{dec , β} ( {σ}_{q , D - 1}^{( n )} , … , {σ}_{q , 0}^{( n )} ) ,$$

for σ_{q,d}⁽ⁿ⁾ [symbol] Σₖ₌₁^{K}η_{k,q,d}⁽ⁿ⁾=Σⱼ₌₀^{β-1}sⱼK_{q,d,j}, where K_{q,d,j}
denotes the number of EDs given that the dth numeral in (8) is sⱼ. Hence, we need to estimate K_{q,d,j}, ∀d, ∀j, to obtain an estimate of υ_{q}⁽ⁿ⁾. In A. Sahin, “Over-the-air computation based on balanced number systems for federated edge learning,” 2023. [Online]. Available: arxiv.org/abs/2210.07012, it is shown that the norm of yₗ⁽ⁿ⁾ can be used as \hat{K}_{q,d,j}=(∥yₗ⁽ⁿ⁾∥₂²−σₙ²)/Eₛ, where q, d, and j can be obtained as q=└1/(Dβ)┘, d=└1/β┘ mod D, and j=1 mod β, respectively, based on the resource mapping rule at the transmitters. Finally, σ_{q,d}⁽ⁿ⁾ and υ_{q}^{(n) can be estimated}

$$as {\hat{σ}}_{q , d}^{( n )} = {\sum }_{j = 0}^{β - 1} {s}_{j} {\hat{K}}_{q , d , j} and {\hat{v}}_{q}^{( n )} = {f}_{drc , β} ( {\hat{σ}}_{q , D - 1}^{( n )} , … , {\hat{σ}}_{q , 1}^{( n )} , {\hat{σ}}_{q , 0}^{( n )} ) , \qquad ( 11 )$$

respectively. Subsequently, c_{c}⁽ⁿ⁾ is updated via (5).

Here, we assume that each ED reports the cardinality of the local partitions, i.e., {| [symbol] _{k,c}⁽ⁿ⁾|, ∀c}, to the ES for | [symbol] _{c}⁽ⁿ⁾| calculation. It is worth noting that the sum for computing | [symbol] _{c}⁽ⁿ⁾| can be evaluated with OAC for further resource saving.

### Enhancements

The performance of the wireless federated k-means with the proposed OAC scheme can be improved further with several methods. To reduce the quantization error, we adopt a similar protocol discussed in A. Sahin, “Over-the-air computation based on balanced number systems for federated edge learning,” 2023. [Online]. Available: arxiv.org/abs/2210.07012 to set vmax adaptively. With this strategy, vmax is updated throughout the communication rounds as

$${v}_{max}^{( n + 1 )} = α \times {max}_{k} {m}_{k}^{( n )} , \qquad ( 12 )$$

where mₖ⁽ⁿ⁾=max_{q}υ_{k,q}⁽ⁿ⁾ is a single parameter transmitted to the ES over where an orthogonal channel from the kth ED.

Since the ES does not know the global dataset, the cardinality of some of the partitions can be 0. Hence, the corresponding centroids cannot be updated with (5). To address this issue, we introduce a generalized re-initialization step as

$${c}_{{c}^{″}}^{( n + 1 )} = {c}_{{c}^{′}}^{( n )} + {n}_{{c}^{″}}^{( n )} , for {c}^{″} ∈ \{ c \vert {𝒮}_{c}^{( n )} \vert < {S}_{min} , {S}_{min} \geq 0 \} ,$$

where c′ is chosen randomly from [symbol] ^{c} [symbol] {1, . . . , C}/ [symbol] and n_{c″}⁽ⁿ⁾ is a zero-mean random Gaussian vector with the variance of σ_{c}². With (III-C), the ES re-initializes a centroid where the cardinality of the corresponding partition is less than Sₘᵢₙ by assigning it to a point nearby a centroid with | [symbol] _{c″}⁽ⁿ⁾|≥S_{min.}

The corresponding algorithm with the aforementioned enhancements is given in Algorithm 1.

### NUMERICAL RESULTS

In this section, we analyze the performance of the wireless federated k-mean with the proposed OAC scheme for the scenario illustrated in FIG. 1 We consider a 100 m×100 m rectangular area for K=100 EDs. We express the user's locations in a 2-D Cartesian coordinate system (i.e., L=2) based on a mixture of Gaussian distributions (10000 points) and a uniform distribution (100 points). We choose the mixture weights, the mean values on the x and y-axes, and the standard deviations on the x-and y axes for the Gaussian mixture model as (0.6, 20, 20, 5, 1), (0.1, 75, 25, 7, 7), (0.1, 50, 50, 10, 1), (0.1, 75, 75, 0.5, 4), and (0.1, 20, 60, 1, 10). For the uniform distribution, we set the distribution boundaries 0 and 100 meters for both x-and y-axes. For the algorithm, we consider C=100 clusters, where the initial values of the centroids are set to the center of the tiles, as shown in FIG. 1. We choose υₘₐₓ⁽⁰⁾=300,

Sₘᵢₙ∈{0,5 }, μ=0.1, α=1.2, σ_{c}²=1, β∈{3,5}, and D={1,3}. We run the algorithm for N=1000 communication rounds. We generate the results for AWGN channel (i.e., h_{k,l}⁽ⁿ⁾=1, ∀k, ∀l), flat fading channel (i.e.,

[symbol] [symbol] [symbol] and frequency selective fading channel (i.e., h_{k,l}⁽ⁿ⁾˜ [symbol] (0, 1), ∀k, ∀l) for SNR∈{10, 20} dB. We regenerate the channel coefficients to model the time variation. We compare our results with the standard k-means algorithm, denoted as the baseline, i.e., the scenario when D is available at the ES for clustering.

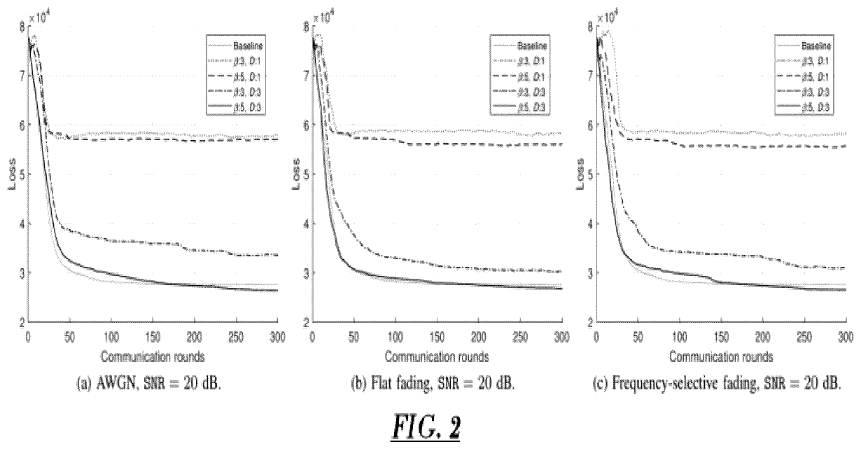

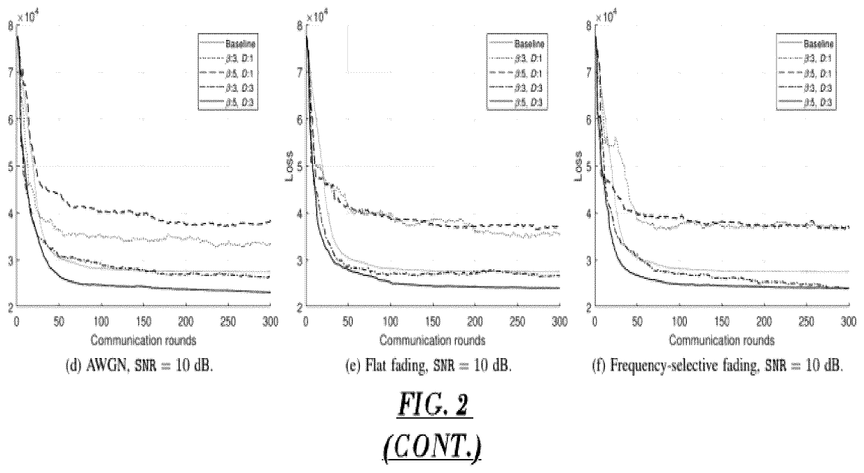

In FIG. 2, we provide the loss in (1) over the communication rounds for Sₘᵢₙ=0 and SNR={10, 20} dB for different channel conditions. In this case, the re-initialization step discussed supra is disabled. For D=1, the OAC scheme introduces high quantization errors for both β=3 and β=5. Hence, for all channel conditions and SNR levels, their performances are worse than the cases for D=2. The proposed scheme performs similarly to the baseline for D=2 and β=5. The performance of the proposed scheme is slightly better than that of the baseline due to the random noise in the communication channel, which allows the algorithm to find a better local optimum point. FIG. 2 shows loss over the communication rounds for the wireless federated k-means with OAC (Sₘᵢₙ=0).

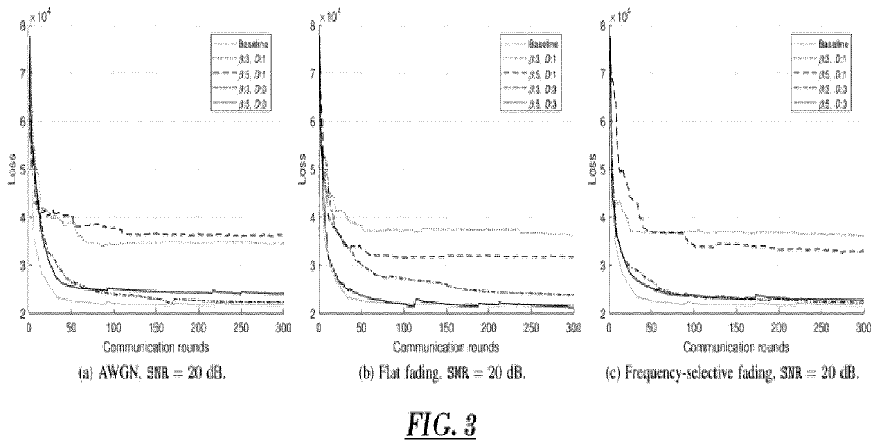

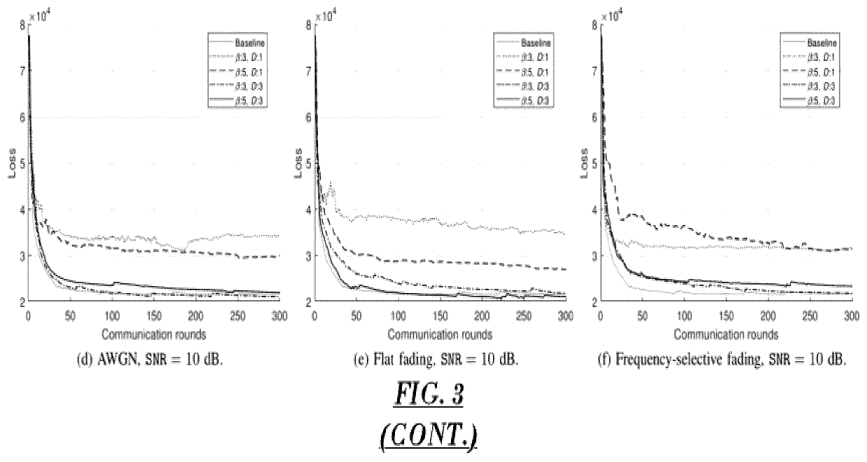

We observe a similar improvement when SNR is reduced to 20 dB from 10 dB. In FIG. 3, we analyze the same scenario in FIG. 2 for Smin=5. FIG. 3 shows loss over the communication rounds for the wireless federated k-means with OAC (Sₘᵢₙ=5). In this case, the partitions have at least 5 data samples. Since the centroids are utilized more effectively, the loss is reduced further as compared to the ones in FIG. 2. The simulation results vary marginally for different channel conditions, indicating that the wireless federated k-means with the OAC and the standard k-means can perform similarly when the quantization error is reduced by increasing D or β. Also, with the proposed scheme, LCβD=2000 complex-valued resources need to be utilized for computing the centroid updates. On the other hand, the same computation without OAC requires LCK_{rbitsrcompression}N_{bits}=32000 for rbits bits/s/Hz, r_{compression}=1/5, and Nbits=8.

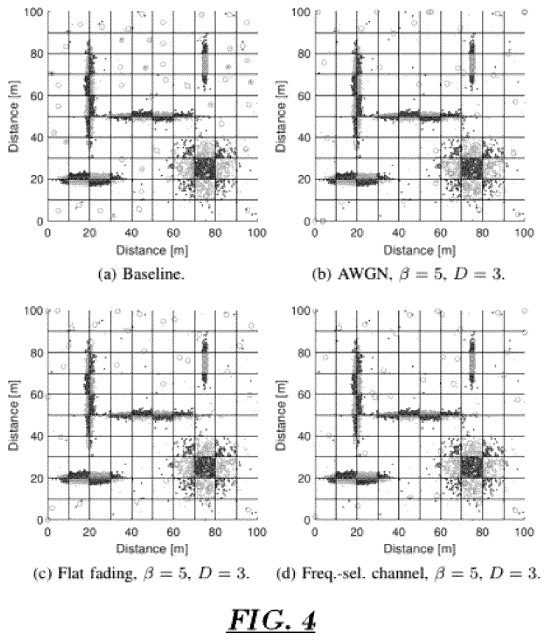

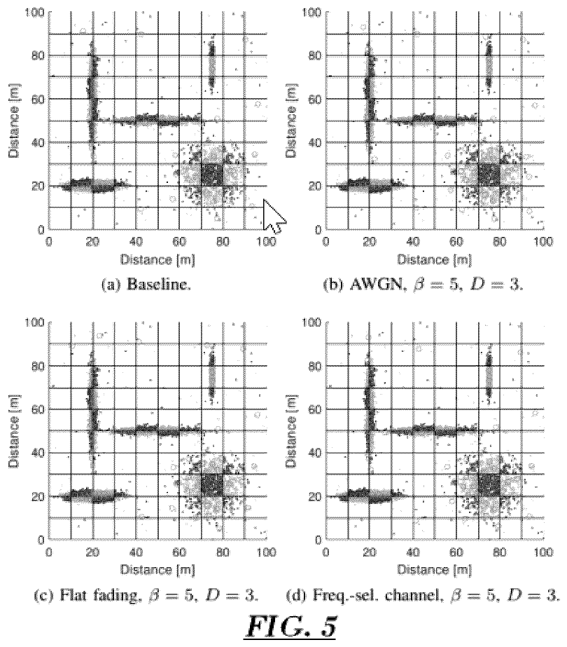

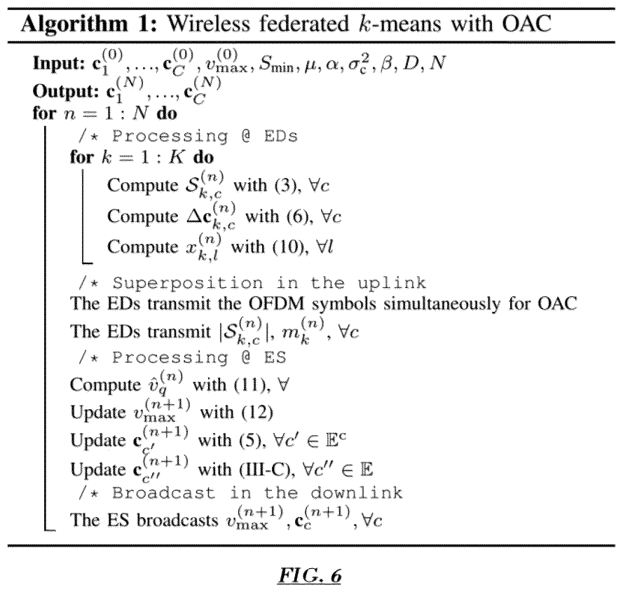

In FIG. 4 and FIG. 5, we provide the locations of the centroids after N=1000 communication rounds for Sₘᵢₙ=0 and Sₘᵢₙ=5. FIG. 4 shows the final centroids for the wireless federated k-means with OAC (SNR=10 dB, Sₘᵢₙ=0). FIG. 5 shows the final centroids for the wireless federated k-means with OAC (SNR=10 dB, Sₘᵢₙ=5). As can be seen, the centroid locations are similar to each other in different channel conditions. We observe that some of the centroids do not change their locations as the local datasets are empty for the baseline. It is also worth noting that some of the centroids are aligned with the data samples for Sₘᵢₙ=0. This is because the corresponding partitions have only one data sample. This implies that the federated k-means algorithm requires any extra precautions such as noise injection for enhancing privacy, see S. Li, S. Hou, B. Buyukates, and S. Avestimehr, “Secure federated clustering,” 2022. These issues are addressed for Smin=5. In this case, the centroids are more localized in densely populated areas, resulting in a better representation of the users' locations. The centroids are likely not to be aligned with a specific user location as a partition has at least 5 data samples in this case.

This disclosure provides using a wireless federated k-means clustering algorithm along with an OAC scheme that does not require CSI at the ES and EDs to address per-round communication latency. By considering data heterogeneity, we utilize a maximum-value adaptation method to reduce quantization error and a re-initialization strategy for a centroid that has a small cardinality in the corresponding partition to improve the performance of the algorithm.

For a customer location clustering scenario, we assess the proposed algorithm under different channel conditions and OAC configurations. Our results indicate that the proposed approach can perform similarly to the standard k-means while reducing the per-round communication latency notably. Future work will analyze the convergence of the proposed approach.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A method for an over-the-air computation (OAC) scheme comprising:
obtaining access to at least one wireless network with at least one edge device and one edge server connected over the at least one wireless network;
reducing per-round communication latency via computing a sum of at least one update for a federated k-means clustering algorithm via signal superposition property of wireless multiple-access channels non-coherently;
eliminating a need for precise phase and time synchronization as the at least one edge device does not use channel state information; and
employing a federated k-means clustering algorithm to reduce the per-round communication latency when implemented over a wireless network.

2. The method of claim 1 further comprising reinitializing at least one centroid to increase performance for heterogeneous data distribution via employing the federated k-means clustering algorithm.

3. The method of claim 2, wherein the at least one centroid has a small cardinality in a corresponding partition.

4. The method of claim 1, further comprising utilizing a maximum-value adaptation method to reduce quantization error.

5. The method of claim 1, wherein a number of complex-valued resources consumed for each communication round can be calculated as LCβD and are not scaled with a number of edge devices.

6. The method of claim 1, wherein the federated k-means clustering algorithm comprises:
Input: c₁⁽⁰⁾,..., c_{C}⁽⁰⁾, vₘₐₓ⁽⁰⁾, Sₘᵢₙ, μ, α, σ_{c}², β, D, N
Output: c₁^{(N)},..., c_{C}^{(N)}
for n = 1 : N do

| | |
|---|---|
| \| | /* Processing @ EDs |
| \| | for k = 1 : K do |
| \| | \| Compute [symbol] _{k,c}⁽ⁿ⁾ with (3), ∀c |
| \| | \| Compute Δc_{k,c}⁽ⁿ⁾ with (6), ∀c |
| \| | \| Compute x_{k,l}⁽ⁿ⁾ with (10), ∀l |
| \| | \|_ |
| \| | /* Superposition in the uplink |
| \| | The EDs transmit the OFDM symbols simultaneously for OAC |
| \| | The EDs transmit \| [symbol] _{k,c}⁽ⁿ⁾\|, mₖ⁽ⁿ⁾, ∀c |
| \| | /* Processing @ ES |
| \| | Compute \hat{v}_{q}⁽ⁿ⁾ with (11), ∀ |
| \| | Update vₘₐₓ⁽ⁿ⁺¹⁾ with (12) |
| \| | Update c_{c′}⁽ⁿ⁺¹⁾ with (5), ∀c′ ∈ [symbol] ^{c} |
| \| | Update c_{c″}⁽ⁿ⁺¹⁾ with (III-C), ∀c″ ∈ [symbol] |
| \| | /* Broadcast in the downlink |
| \| | The ES broadcasts vₘₐₓ⁽ⁿ⁺¹⁾, c_{c}⁽ⁿ⁺¹⁾, ∀c |
| \|_{—} | |

7. A system for addressing per round communication latency comprising:
at least one edge device connected to at least one edge server over at least one wireless network;
employing at least one wireless federated k-means clustering algorithm along with an over-the-air computation scheme such that no channel state information is required for the at least one edge device or the at least one edge server;
wherein employing the at least one wireless federated k-means clustering algorithm further:
utilizes a maximum-value adaption method to reduce at least one quantization error; and
employs a re-initialization strategy for at least one centroid.

8. The system of claim 7, wherein the at least one centroid has a small cardinality.

9. The system of claim 7, a number of complex-valued resources consumed for each communication round can be calculated as LCβD and are not scaled with a number of edge devices.

10. The system of claim 7, wherein the federated k-means clustering algorithm comprises:
Input: c₁⁽⁰⁾,..., c_{C}⁽⁰⁾, vₘₐₓ⁽⁰⁾, Sₘᵢₙ, μ, α, σ_{c}², β, D, N
Output: c₁^{(N)},..., c_{C}^{(N)}
for n = 1 : N do

| | |
|---|---|
| \| | /* Processing @ EDs |
| \| | for k = 1 : K do |
| \| | \| Compute [symbol] _{k,c}⁽ⁿ⁾ with (3), ∀c |
| \| | \| Compute Δc_{k,c}⁽ⁿ⁾ with (6), ∀c |
| \| | \| Compute x_{k,l}⁽ⁿ⁾ with (10), ∀l |
| \| | \|_ |
| \| | /* Superposition in the uplink |
| \| | The EDs transmit the OFDM symbols simultaneously for OAC |
| \| | The EDs transmit \| [symbol] _{k,c}⁽ⁿ⁾\|, mₖ⁽ⁿ⁾, ∀c |
| \| | /* Processing @ ES |
| \| | Compute \hat{v}_{q}⁽ⁿ⁾ with (11), ∀ |
| \| | Update vₘₐₓ⁽ⁿ⁺¹⁾ with (12) |
| \| | Update c_{c′}⁽ⁿ⁺¹⁾ with (5), ∀c′ ∈ [symbol] ^{c} |
| \| | Update c_{c″}⁽ⁿ⁺¹⁾ with (III-C), ∀c″ ∈ [symbol] |
| \| | /* Broadcast in the downlink |
| \| | The ES broadcasts vₘₐₓ⁽ⁿ⁺¹⁾, c_{c}⁽ⁿ⁺¹⁾, ∀c |
| \|_{—} | |
